(19) United States
(12) Patent Application Publication
(10) Pub. No.: US 2024/0277449 A1
(43) Pub. Date: Aug. 22, 2024

(54) DEEP LEARNING FOR GENERATING INTERMEDIATE ORTHODONTIC ALIGNER STAGES

(71) Applicant: 3M INNOVATIVE PROPERTIES COMPANY, St. Paul, MN (US)

(72) Inventors: Benjamin D. Zimmer, Hudson, WI (US); Cody J. Olson, Ham Lake, MN (US); Nicholas A. Stark, Woodbury, MN (US); Nicholas J. Raddatz, St. Paul, MN (US); Alexandra R. Cunliffe, St. Paul, MN (US); Guruprasad Somasundaram, Woodbury, MN (US)

(21) Appl. No.: 18/292,217

(22) PCT Filed: Aug. 8, 2022
(86) PCT No.: PCT/IB2022/057373

§ 371 Date: Jan. 25, 2024

Related U.S. Application Data
(60) Provisional application No. 63/232,414, filed on Aug. 12, 2021.

(51) Int. Cl. A61C 7/00; A61C 7/08; G06N 3/0475

(52) U.S. Cl. CPC A61C 7/002; A61C 7/08; G06N 3/0475

(57) ABSTRACT

Methods for generating intermediate stages for orthodontic aligners using machine learning or deep learning techniques. The method receives a malocclusion of teeth and a planned setup position of the teeth. The malocclusion can be represented by translations and rotations, or by digital 3D models. The method generates intermediate stages for aligners, between the malocclusion and the planned setup position, using one or more deep learning methods. The intermediate stages can be used to generate setups that are output in a format, such as digital 3D models, suitable for use in manufacturing the corresponding aligners.

### BACKGROUND

Intermediate staging of teeth from a malocclusion stage to a final stage requires determining accurate individual teeth motions in a way that teeth are not colliding with each other, the teeth move toward their final state, and the teeth follow optimal and preferably short trajectories. Since each tooth has six degrees-of-freedom and an average arch has about fourteen teeth, finding the optimal teeth trajectory from initial to final stage has a large and complex search space. A need exists to simplify this optimization problem.

### SUMMARY

A method for generating intermediate stages for orthodontic aligners includes receiving a malocclusion of teeth and a planned setup position of the teeth. The method generates intermediate stages for aligners, between the malocclusion and the planned setup position, using one or more deep learning methods. The intermediate stages can be used to generate setups that are output in a format, such as digital 3D models, suitable for use in manufacturing the corresponding aligners.

### BRIEF DESCRIPTION OF THE DRAWINGS

FIG. 1 is a diagram of a system for generating intermediate stages for orthodontic appliances.

FIG. 2 is a flow chart of a method for generating intermediate stages for orthodontic appliances.

FIG. 3 is a diagram illustrating generating intermediate targets for orthodontic appliances.

FIG. 4 is a diagram illustrating a malocclusion and corresponding intermediate stage.

FIG. 5 is a diagram of a user interface for side-by-side display of staging options generated by different staging approaches.

### DETAILED DESCRIPTION

Embodiments include a possibly partially to fully automated system using deep learning techniques to generate a set of intermediate orthodontic stages that allow a set of teeth to move from a maloccluded to a final setup state or allow for a partial treatment from one state to another state (e.g., an initial state to a particular intermediate state). The stages include an arrangement of teeth at a particular point in treatment. Each arrangement of teeth (“state” or “setup”) can be represented by a digital three-dimensional (3D) model. The digital setups can be used, for example, to make orthodontic appliances, such as clear tray aligners, to move teeth along a treatment path. The clear tray aligners can be made by, for example, converting the digital setup into a corresponding physical model and thermoforming a sheet of material over the physical model or by 3D printing the aligner from the digital setup. Other orthodontic appliances, such as brackets and archwires, can also be configured based upon the digital setups.

The system uses machine learning, and particularly deep learning, techniques to train a model with historical data for intermediate stages. With one known arrangement or part of a sequence of arrangements, the system predicts the next arrangement or sequence of arrangements. For example, the system uses a neural network to take two different states, predict a state halfway between the different states, and call the neural network recursively for the resolution desired. In a time series example, a recurrent neural network predicts the next state or sequence of states instead of using interpolation to find the next state. As another example, a generative model takes the start state, end state, and fractions through a path between the start and end states as inputs to predict an intermediate state.

The following are advantages of a deep learning, or machine learning, approach for intermediate staging: near-real time results; the ability to easily adapt to different treatment protocols; and the ability for the network to learn doctor or practitioner preferences over time in order to efficiently generate a treatment plan that the doctor or practitioner prefers, also improving customer satisfaction.

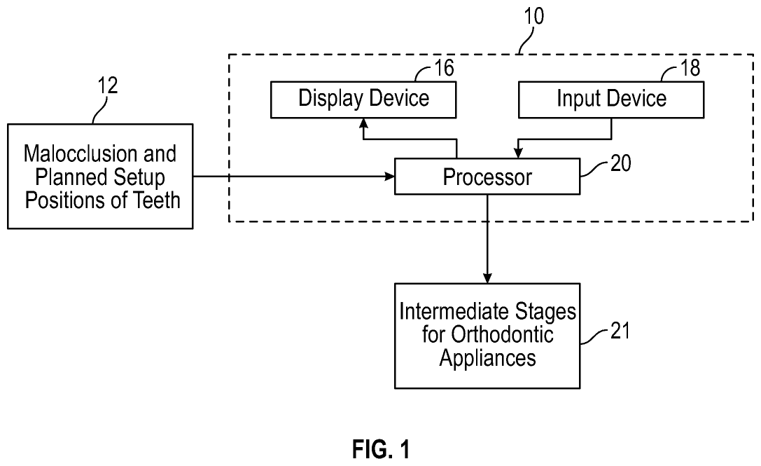

FIG. 1 is a diagram of a system 10 for generating intermediate stages for orthodontic appliances (21). System 10 includes a processor 20 receiving a malocclusion and planned setup positions of teeth (12). The malocclusion can be represented using translations and rotations (together transformations). The transformations can be derived from, for example, a digital 3D model (mesh) of the malocclusion. Systems to generate digital 3D images or models based upon image sets from multiple views are disclosed in U.S. Pat. Nos. 7,956,862 and 7,605,817. These systems can use an intra-oral scanner to obtain digital images from multiple views of teeth or other intra-oral structures, and those digital images are processed to generate a digital 3D model representing the scanned teeth and gingiva. System 10 can be implemented with, for example, a desktop, notebook, or tablet computer.

### Deep Learning for Intermediate Stage Generation

As the system acquires more data, machine learning methods and particularly deep learning methods start performing on par or exceed the performance of explicitly programmed methods. Deep learning methods have the advantage of removing the need for hand-crafted features as they are able to infer useful features using a combination of non-linear functions of higher dimensional latent or hidden features, directly from the data through the process of training. While trying to solve the staging problem, directly operating on the malocclusion 3D mesh can be desirable. Methods such as PointNet, PointCNN, MeshCNN, and others are suited for this problem. Alternatively, deep learning can be applied to processed mesh data. For example, it can be applied after the mesh of the full mouth has been segmented to individual teeth and canonical tooth coordinate systems have been defined. At this stage, useful information such as tooth positions, orientations, dimensions of teeth, gaps between teeth, and others is available. Tooth positions are cartesian coordinates of a tooth's canonical origin location which is defined in a semantic context. Tooth orientations can be represented as rotation matrices, unit quaternions, or another 3D rotation representation such as Euler angles with respect to a global frame of reference. Dimensions are real valued 3D spatial extents and gaps can be binary presence indicators or real valued gap sizes between teeth, especially in instances when certain teeth are missing. Deep learning methods can be made to use various heterogeneous feature types.

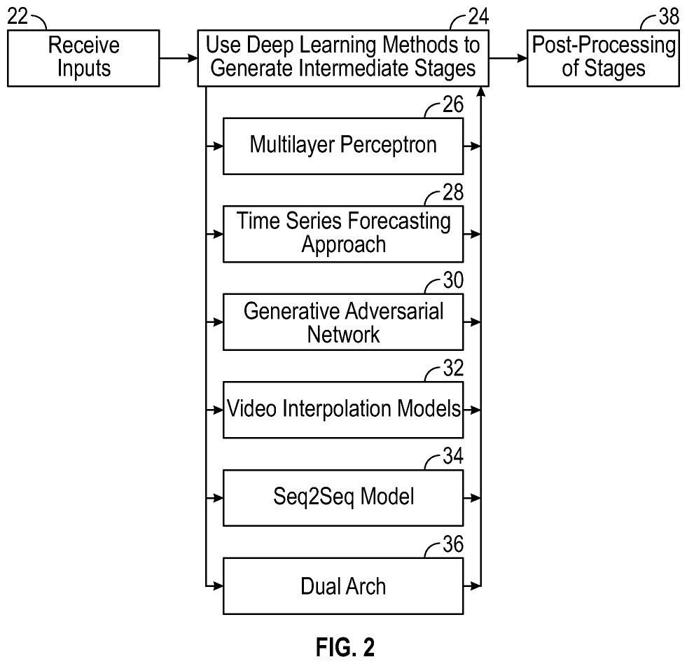

There are several candidate models that can be useful, as identified in the flow chart of FIG. 2. The method in FIG. 2 can be implemented, for example, in software or firmware modules for execution by a processor such as processor 20. The method receives inputs (step 22), such as a malocclusion and planned setup positions of teeth. The malocclusion can be represented by tooth positions, translations, and orientations, or by a digital 3D model or mesh. The method uses deep learning algorithms or techniques to generate intermediate stages of orthodontic appliances based upon and to correct the malocclusion (step 24). The intermediate stages can be used to generate setups output as digital 3D models that can then be used to manufacture the corresponding aligners. These deep learning methods can include the following as further explained below: Multilayer Perceptron (26); Time Series Forecasting Approach (28); Generative Adversarial Network (30); Video Interpolation Models (32); Seq2Seq Model (34); and Dual Arch (36). After generating the intermediate stages, the method can perform post-processing of the stages (step 38).

### Multilayer Perceptron (26)

The goal is to predict the tooth positions and orientations in intermediate stages using the malocclusion and setup positions. A multilayer perceptron (MLP) architecture takes a set of features as input, then passes these features through a series of linear transforms followed by non-linear functions, outputting a set of numeric values. The input features are the translational and rotational difference between malocclusion and setup positions, and the outputs are the translational and rotational differences between malocclusion and middle positions. By calling the trained MLP model recursively, the system can create a set of target states that represent tooth movement from malocclusion to position 1, position 1 to position 2, . . . , position N to setup. The system subsequently performs linear interpolation in between these target states to achieve tooth movements that adhere to per-stage tooth movement limits.

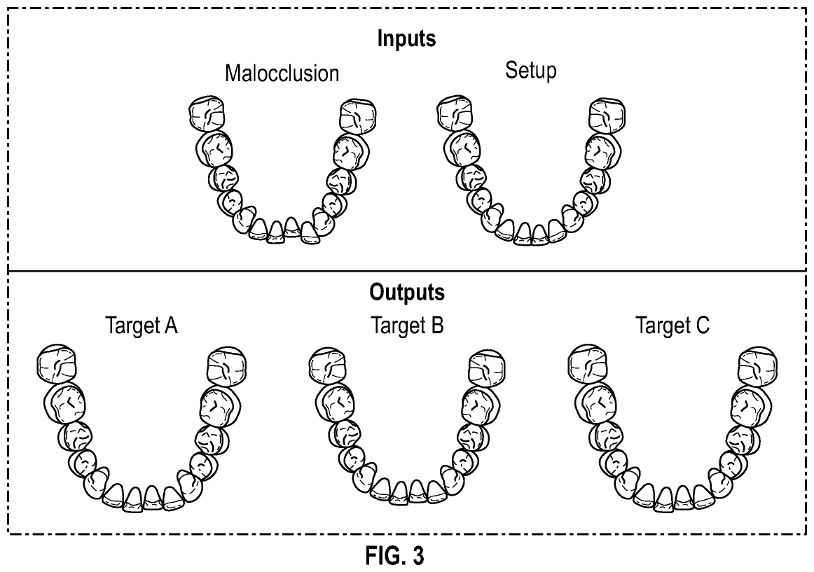

This model was trained on tooth movements from historic clear tray aligner cases. Some results on an independent test set that was not used during training are displayed in FIG. 3, which illustrates intermediate targets generated by a MLP that predicts the tooth movement in middle positions. Target A was produced using malocclusion→setup movement as the input feature vector. Target B was produced using malocclusion→Target A, and Target C was produced using Target A→setup.

### Time Series Forecasting Approach (28)

The staging problem can be posed as a forecasting problem. This can be formulated in a few different ways:
1. Given a current stage, predict the next stage.
2. Given stages up to n−1, predict the nth stage.
3. Given stages up to n−1, predict the next k stages (sequence generation).

All of these approaches can be performed using Recurrent Neural Network based architectures such as RNN, Gated Recurrent Unit and Long Short Term Memory neural networks. For sequence generation an encoder decoder type architecture with any of the aforementioned algorithms can also be used.

### Generative Adversarial Network (GAN) (30)

GANs can be used to create computer-generated examples that are essentially indistinguishable from examples generated by a human. The models include two parts—a generator that generates new examples and a discriminator that attempts to differentiate between examples produced by the generator and human-generated examples. The performance for each part is optimized through model training on example data.

For this application, we trained a GAN to generate tooth movements. The generator takes as input 1) the tooth positions in the malocclusion and final positions, and 2) the fraction of the way through staging for which we want to generate new tooth positions. Once we have trained the GAN, the system can call the trained generator multiple times to generate tooth positions at multiple points throughout treatment.

### Video Interpolation (Video Inbetweening) Models (32)

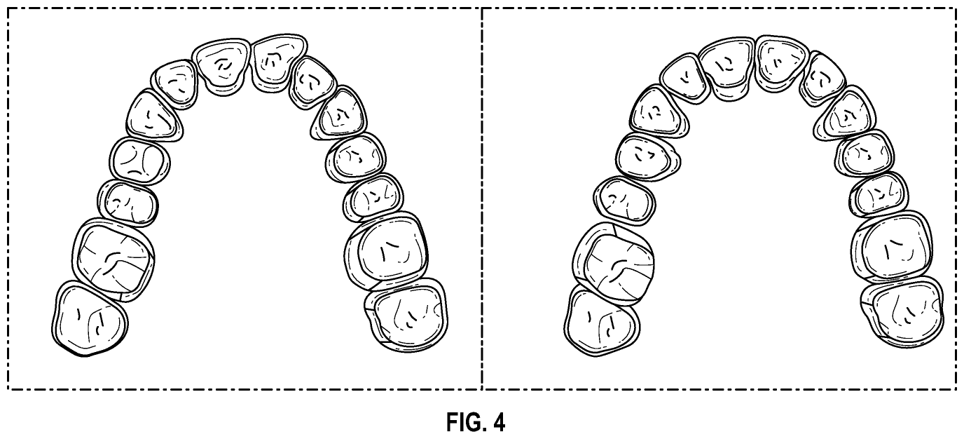

Video interpolation models are used to produce frames that occur between two frames of a video. This technology is used in technologies such as generating slow motion video and frame recovery in video streaming. For the purposes of this embodiment, video interpolation models were used to generate the intermediate stages that occur between the two end stages, malocclusion and final setup. Specifically, we trained a model that is a modification of the bidirectional predictive network architecture. This network uses two encoder models to encode the malocclusion stage and final stage teeth positions and orientations into a latent feature space. These features are then passed to a decoder model that predicts tooth positions and orientations that occur in between the malocclusion and final tooth positions. FIG. 4 illustrates a malocclusion (left image) and an intermediate stage (right image) generated using a bi-directional neural network.

### Seq2Seq Model (34)

Seq2Seq models are used to generate a sequence of data given an input sequence of data. They are often used in language processing applications for language translation, image captioning, and text summarization. For this embodiment we trained a seq2seq model to generate a sequence of intermediate stage tooth positions between the malocclusion and final tooth positions.

The model constructed is an encoder-decoder model. The encoder portion of the model encodes the input sequence of malocclusion and final tooth positions into a hidden vector of features using an MLP network. The decoder portion of the model then generates the next stage tooth positions from the encoded input sequence features as well as the sequence of all previous tooth position stages using a long-short term memory (LSTM) network. The full output sequence of intermediate stages is generated by recursively predicting the next stage positions using the decoder network until the model generates a flag that signals the network to stop.

### Dual Arch (36)

To further improve the results of staging, both upper and lower arches can be considered when searching for a collision free path. Cross arch interference can be avoided by analyzing the occlusal map for target stages, leading to better tracking, more patient comfort and ultimately a successful treatment. This dual arch method can use any of the deep learning methods described herein when generating intermediate stages for both the upper and lower arches.

### Post-Processing (38)

The stages created by the deep learning model can be displayed to a user directly, or they can go through post-processing steps to make them more amenable for use. Examples of post-processing steps that can be desired include the following.

1. Reset fixed teeth—Teeth that the doctor or practitioner has specified should not move during treatment can be returned to their initial position.

2. Remove collisions—As a post-processing step, collisions can be removed from the stages that are generated by the machine or deep learning algorithm, if the algorithm resulted in collisions. The following are examples of methods for post-processing collision removal.

2a. Move teeth along the arch to remove collisions. First, compute the total amount of space and total amount of collision present in the arch. If there is more collision than space present, then pack all of the teeth, starting with the mesial-most tooth in each quadrant, from their current positions distally until they are no longer in collision with their mesial neighbor.

If there is more space than collision, then try to preserve the spaces proportionally in the resultant packing. To do this, first compute the excess space present at the starting positions (total space−total collision=T). Starting with the mesial-most tooth in each quadrant, then either:

If starting in collision with mesial neighbor, move the tooth distally out of collision with that neighbor; or

If starting with an initial space S with its mesial neighbor, move the tooth such that it retains a space [S*(S/T)] with its mesial neighbor in the final position

2b. Iterative collision removal. The general problem statement is for teeth to be moved as little as possible from their initial positions in order to reduce or remove collisions between teeth. An iterative search and optimization algorithm can be used to identify a set of tooth positions that minimize collision between teeth, while also penalizing perturbation of teeth from their starting positions. One implementation of this approach uses Levenberg-Marquardt optimization with the following cost function:

Sum of collisions between all teeth+Sum of squared movement of teeth from their starting positions.

The search can also be biased to only move teeth in a certain direction. For example, one implementation limits tooth movement to the x-y plane and prevents teeth from moving in a direction opposite to the direction that the teeth move between the malocclusion and setup position.

### Customization

Customization of these models to perform different types of treatment plans can be achieved by training the model with data belonging to that category, for example cases from a particular doctor or practitioner, cases where a certain treatment protocol was applied, or cases with few refinements. This approach can eliminate the need to code a new protocol as it only requires training the model on the right subset of data. Alternatively, a deep learning model has the possibility of learning which protocol to apply to a specific case instead of having to be instructed (i.e., the network will automatically perform expansion because it identifies crowding), making it a more adaptable approach that does not require explicit protocol development in order to learn the correct treatment strategies to apply.

### Comparison

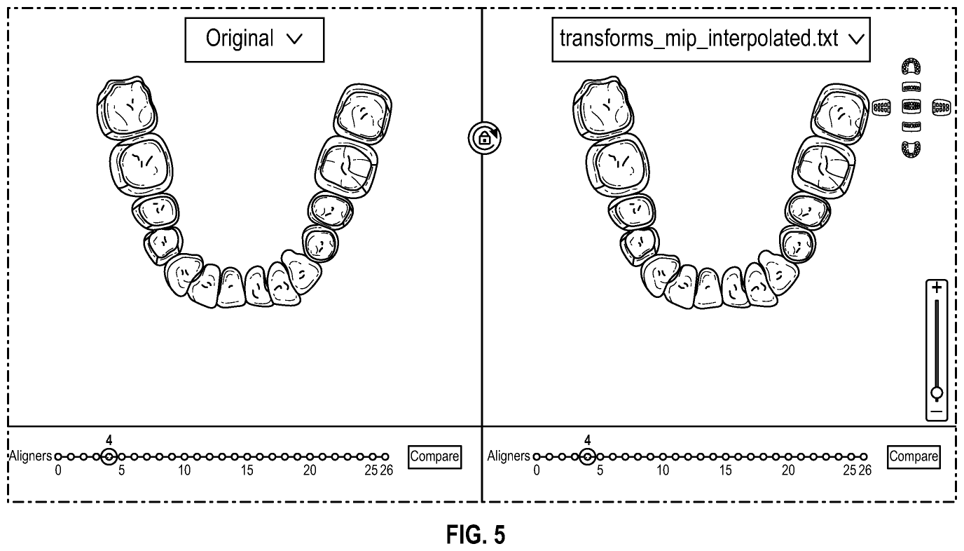

Deep learning approaches enable fast generation of multiple staging options, which can then be displayed to doctors (or practitioners) and patients so that they can compare treatments and select an option that best suits their preferences. FIG. 5 illustrates a user interface that displays different staging options side-by-side for a particular stage using staging approaches such as those described herein. The user interface in FIG. 5 can be displayed on, for example, display device 16. As shown in FIG. 5, the user interface can include a command function in the bottom section to compare staging options at a particular stage of the planned treatment, a zoom function, a command icon in the center to rotate the images, and command icons in the upper right section to select a view of the staging options.

1. A method for generating intermediate stages for orthodontic aligners, comprising steps of performed by a processor:
receiving a malocclusion of teeth and a planned setup position of the teeth;
generating intermediate stages for aligners, between the malocclusion and the planned setup position, using one or more deep learning methods; and
outputting the intermediate stages.

2. The method of claim 1, wherein the receiving step comprises receiving translations and rotations of teeth for the malocclusion.

3. The method of claim 1, wherein the receiving step comprises receiving a digital 3D model for the malocclusion.

4. The method of claim 1, wherein the receiving step comprises receiving a final stage for the planned setup position.

5. The method of claim 1, wherein the outputting step comprises outputting the intermediate stages as digital 3D models.

6. The method of claim 1, wherein the generating step comprises using a multilayer perceptron to generate the intermediate stages.

7. The method of claim 1, wherein the generating step comprises using a time series forecasting approach to generate the intermediate stages.

8. The method of claim 1, wherein the generating step comprises using a generative adversarial network to generate the intermediate stages.

9. The method of claim 1, wherein the generating step comprises using video interpolation models to generate the intermediate stages.

10. The method of claim 1, wherein the generating step comprises using a seq2seq model to generate the intermediate stages.

11. The method of claim 1, wherein the generating step comprises using a dual arch method to generate the intermediate stages.

12. The method of claim 1, further comprising performing post-processing of one or more of the intermediate stages.

13. The method of claim 12, wherein the post-processing step comprises resetting fixed teeth for the intermediate stages.

14. The method of claim 12, wherein the post-processing step comprises removing collisions between teeth for the intermediate stages.

15. The method of claim 1, wherein:
the generating step comprises generating intermediate stages for a particular point in treatment by at least two different deep learning methods; and
the outputting step comprises displaying the intermediate stages for the particular point in treatment.

16. The method of claim 15, wherein the displaying step comprises displaying the intermediate stages for the particular point in treatment side-by-side within a user interface.

17. A system for generating intermediate stages for orthodontic aligners, comprising a processor configured to:
receive a malocclusion of teeth and a planned setup position of the teeth;
generate intermediate stages for aligners, between the malocclusion and the planned setup position, using one or more deep learning methods; and
output the intermediate stages.

18. The system of claim 17, wherein to receive the malocclusion, the processor is configured to receive translations and rotations of teeth for the malocclusion.

19. The system of claim 17, wherein to receive the malocclusion, the processor is configured to receive a digital 3D model for the malocclusion.

20. The system of claim 17, wherein to receive the malocclusion, the processor is configured to receive a final stage for the planned setup position.
